(19) United States
(12) Patent Application Publication
(10) Pub. No.: US 2026/0106126 A1
(43) Pub. Date: Apr. 16, 2026

(54) ELEMENTARY PARTICLE DETECTOR AND ASSOCIATED DETECTION METHOD

(71) Applicants: UNIVERSITE CLAUDE BERNARD LYON 1, VILLEURBANNE (FR); CENTRE NATIONAL DE LA RECHERCHE SCIENTIFIQUE, PARIS (FR)

(72) Inventor: Imad LAKTINEH, THIL (FR)

(73) Assignees: UNIVERSITE CLAUDE BERNARD LYON 1, VILLEURBANNE (FR); CENTRE NATIONAL DE LA RECHERCHE SCIENTIFIQUE, PARIS (FR)

(21) Appl. No.: 19/114,037

(22) PCT Filed: Sep. 22, 2023
(86) PCT No.: PCT/FR2023/051451

§ 371 Date: Mar. 21, 2025

(30) Foreign Application Priority Data
Sep. 23, 2022 (FR) FR2209691

(51) Int. Cl. H01J 43/18; G01T 1/29

(52) U.S. Cl. CPC H01J 43/18; G01T 1/2985

(57) ABSTRACT

An elementary particle detector including dynodes capable of converting an elementary particle into an electron avalanche, conductive grids capable of being crossed by accelerated electrons, and each being defined by a unique electrical potential, each unique electrical potential being chosen so that the unique electrical potential of the conductive grid is strictly lower than the unique electrical potential applied to the conductive grid which follows it along the detection direction, at least one signal sensor capable of measuring an electrical signal produced by the accelerated electrons when they cross the conductive grids, and a control unit configured to determine, from the electrical signal, a conversion dynode at which the conversion of the elementary particle has taken place. The invention also relates to a method for detecting elementary particles.

### TECHNICAL FIELD OF THE INVENTION

The invention relates to an elementary particle detector and a method for detecting elementary particles.

### STATE OF THE ART

The detection of the elementary particles and the characterization of their properties constitutes the heart of the discipline of particle physics. One of the major challenges of the particle detectors using the concept of time of flight (or TOF) is to have an excellent temporal resolution. When this concept is applied to the detection of gammas, the conversion rate of the latter becomes an element as important as the temporal resolution.

In addition, there are configurations where it is also important to propose a system that also allows for good spatial resolution. For example, document FR3062926 of the state of the art describes an elementary particle detector comprising a reading plate including conductive tiles used to improve the spatial resolution.

In the particular case of Positron Emission Tomography (PET) scanners, it is necessary to design a detection system that allows to have both a high conversion efficiency of the gammas produced during the annihilation of the positron with an electron of the medium and at the same time have a remarkable temporal resolution that allows the detection of two gamma photons emitted in coincidence to be well separated and thus reject the very significant background noise consisting of the fortuitous gamma photons.

It is known from the state of the art to use scanners using fast-response crystals that contain heavy elements that promote the conversion of the gamma photons. These crystals, such as lutetium-yttrium oxyorthosilicate, or LYSO, associated with photodetectors make it possible to obtain efficiencies, or conversion rates, in the range of 50%, and a temporal resolution in the range of 200 picoseconds (ps) in the best cases. However, these crystals are relatively expensive, which constitutes a barrier to the manufacture of detectors comprising such crystals.

Furthermore, in order to improve the quality of particle detection, it would be desirable to develop detectors with improved temporal resolution, typically by a factor of 10, compared to what already exists, in order to increase the signal-to-noise ratio, and to improve the quality of the scan while reducing the radioactive dose injected to patients. For several years, and with relentless efforts worldwide, this goal remains out of reach if we wish to achieve a performance of around ten picoseconds of temporal resolution.

To improve the temporal resolution, it is known to use microchannel plates-type (MCP) detectors, known for their extremely precise temporal response (in the range of 5-10 ps). Document FR3091953 discloses in particular an elementary particle detector comprising a sensor configured to detect an electrical signal and a processing unit configured to determine a crossing time according to the signal detected by the sensor. This solution is satisfactory in that it makes it possible to improve the temporal resolution, but does not propose an improvement in the conversion rate. Indeed, MCPs comprise channels in the form of lead glass tubes and propose, depending on their thickness, a conversion rate ranging from 1% to 10%. A conversion rate of 9% has also been obtained with MCPs 11 mm thick.

It has also been found that increasing the thickness of the MCPs and therefore the length L of the channels, increases the conversion rate. However, it has also been found that increasing the gain of an MCP is saturated beyond a certain L/D ratio around 140, where D is the diameter of the channels. Thus the temporal performance, which depends on the gain, is reduced by increasing the length L of the channels without increasing their diameter D. Indeed, this increases the dispersion of the particle conversion point without compensating for this by increasing the gain.

A solution to this problem could be to increase the diameter D of the channels to maintain the same L/D ratio. However, such a construction would also increase the temporal dispersion by increasing the dispersion of the electron paths during the amplification process in the channels of the MCP. Thus, both cases presented above would lead to a deterioration in the temporal performance of the MCPs due to the increase in the temporal dispersion not compensated by an increase in the gain.

Another solution would be to use a stack of MCPs. However, for known systems using a set of stacked MCPs, it is necessary to multiply the electronic elements to measure the signal in order to make the measurement reliable. Indeed, the electronics are reduced compared to the number of layers of MCPs, then the temporal and spatial resolution is degraded. Consequently, if we want to obtain a high-performance particle detector, its manufacturing price increases with the increase in the layers of MCPs used.

### SUBJECT OF THE INVENTION

The present invention aims to propose a solution which responds to all or part of the aforementioned problems.

This goal can be achieved thanks to the implementation of an elementary particle detector configured to detect at least one elementary particle, said elementary particle detector comprising:
dynodes stacked along a detection direction between a receiving end and a reading end, wherein each dynode is capable of converting an elementary particle entering the dynode into an electron avalanche, said dynode comprising a plurality of channels which comprise an emissive material capable, in response to an impact of said elementary particle, of generating, on average, more than one electron;
conductive grids where each conductive grid is either interposed between two adjacent dynodes or disposed at the reading end and/or at the receiving end; each conductive grid being capable of being crossed by electrons, and being defined by a unique electrical potential to allow the application of a potential difference with at least one other conductive grid along the detection direction, said potential difference being likely to accelerate electrons between said two conductive grids, each unique electrical potential being chosen so that the unique electrical potential of said conductive grid is strictly lower than the unique electrical potential applied to the conductive grid which succeeds it along the detection direction;
at least one signal sensor capable of measuring an electrical signal produced by the accelerated electrons as they cross the conductive grids, said electrical signal depending on the potential differences applied between the conductive grids;
a control unit configured to determine, from the electrical signal measured by the signal sensor, a conversion dynode corresponding to the dynode at which the conversion of the elementary particle has taken place.

The arrangements described above make it possible to propose a low-cost elementary particle detector, with improved conversion efficiency, while keeping good temporal resolution. Indeed, the absence of fast-response crystals for the conversion of the elementary particles makes it possible to reduce the manufacturing cost of the elementary particle detector. In addition, the application of unique electrical potentials between the conductive grids makes it possible to have gain jumps at each passage of a dynode, which makes it possible to efficiently determine at which dynode the conversion of the elementary particle has taken place, this determination being carried out with reduced detection electronics.

The term “unique electrical potential” means that the electrical potential of each conductive grid is distinct from the electrical potentials of all other conductive grids.

The elementary particle detector may further have one or several of the following characteristics, taken alone or in combination.

Generally, the unique electrical potentials defining the conductive grids are negative. Thus the electrical potential defining the first dynode disposed closest to the receiving end is lower in algebraic value than that of the second dynode which succeeds it along the detection direction going towards the reading end, and so on.

According to one embodiment, the elementary particle detector is configured to detect time of flight of the elementary particle, for example for Positron Emission Tomography applications.

Generally, the elementary particle detector is particularly suitable for the detection of gamma photons.

According to one embodiment, the dynodes have a thickness, counted along the detection direction, that is equal to within 10% of 500 μm. Dynodes 500 μm thick are readily available commercially. Thicker dynodes (in the range of a few millimeters) may also be used.

According to one embodiment, each dynode comprises a receiving surface at which the electrons or the elementary particle are received.

According to one embodiment, each dynode comprises an emergence surface opposite said receiving surface, said emergence surface forming a conductive grid.

According to one embodiment, the receiving surface of each dynode faces the receiving end.

According to one embodiment, the dynode is a microchannel plate known by the acronym MCP. The dynode is crossed vertically, from one side to the other, by several million channels per square centimeter, often called “microchannels”.

According to one embodiment, the channels of the dynode open at the emergence surface.

According to one embodiment, each dynode comprises a receiving surface, said receiving surface forming a conductive grid.

According to one embodiment, the receiving surface of the dynodes is metallized.

According to one embodiment, the emergence surface of the dynodes is metallized, so that each receiving and/or emergence surface forms a conductive grid. In other words, each conductive grid is included in a dynode at the receiving and/or emergence surface. The arrangements described above make it possible in particular to form a transparent grid.

According to one embodiment, each dynode is arranged relative to the dynode preceding it along the detection direction such that the electrons coming from one of the channels of the preceding dynode are distributed across several channels of this dynode, so as to amplify the electron avalanche. Thus, from the dynode at which the conversion has taken place, the number of electrons will increase. In this way, the gain increases from one dynode to the next along the detection direction.

Thus, it is possible to increase the number of electrons in the electron avalanche, to amplify the signal to be detected. The reliability of the measurement and its precision are then improved.

According to one embodiment, the elementary particle detector comprises capacitive decoupling elements, wherein each capacitive decoupling element is electrically connected to one of the conductive grids, and configured to provide an electrical isolation between the conductive grid to which it is connected and the at least one signal sensor.

According to one embodiment, the elementary particle detector comprises capacitive decoupling elements, wherein each capacitive decoupling element is electrically connected to one of the conductive grids placed at the emergence surface of the dynode, and configured to provide an electrical isolation between the conductive grid to which it is connected and the at least one signal sensor.

According to one embodiment, the capacitive decoupling elements are configured to withstand a potential difference of a few kilo volts, or more.

According to one embodiment, the at least one signal sensor comprises a first signal sensor, a second signal sensor and a third signal sensor spaced apart from each other, and the capacitive decoupling elements comprise, for each conductive grid, for example placed at the emergence surface of the dynode, a first capacitive decoupling element, a second capacitive decoupling element, and a third capacitive decoupling element spaced apart from each other; said first capacitive decoupling element being configured to provide an electrical isolation between the conductive grid and the first signal sensor, said second capacitive decoupling element being configured to provide an electrical isolation between the conductive grid and the second signal sensor, and said third capacitive decoupling element being configured to provide an electrical isolation between the conductive grid and the third signal sensor.

Thus, it is possible to collect and measure the electrical signal along three separate measuring lines, said measuring lines being electrically isolated with respect to each conductive grid. In this way, it is possible to electrically isolate each measuring line from the electrical voltages applied to the conductive grids while measuring an electrical signal.

According to one embodiment, the electrical signal is a total electrical signal, corresponding to an electrical signal measured on a measuring line connected to the conductive grids.

According to one embodiment, the first signal sensor is configured to measure a first electrical signal and a first crossing time, the second signal sensor is configured to measure a second electrical signal and a second crossing time, the third signal sensor is configured to measure a third electrical signal and a third crossing time. The control unit is then configured to determine a conversion place corresponding to the position where the conductive grid disposed downstream of the conversion dynode along the detection direction is crossed by the electron avalanche, said conversion place being determined by a lateralization method, as a function of the first crossing time, the second crossing time, and the third crossing time, and as a function of the position where the first electrical signal, the second electrical signal, and the third electrical signal are measured.

The above-described arrangements make it possible to propose a particle detector configured to determine both the dynode at which the conversion of the elementary particle has taken place (for example by using the amplitude of the collected electrical signal), but also the conversion place on the next conductive grid corresponding approximately to the position where the conversion has taken place. The spatial and temporal resolution of the detection is thus improved. It is well understood that the conversion place corresponds to a position on the conductive grid located below the conversion dynode, the exact position of the conversion being located in the volume of the conversion dynode near the conversion place.

According to one embodiment, each of the first, second and third crossing times corresponds to the instant when the corresponding electrical signal was detected by the corresponding signal sensor.

According to one embodiment, the at least one signal sensor comprises:
an analog circuit configured to measure a total electrical amplitude of the electrical signal; and/or
a time converter configured to measure a crossing time of the electrons through the conductive grids.

Thus, the signal sensor makes it possible to measure either the arrival time of the electrical signal, or the total amplitude of the signal, or both at the same time.

These parameters being used by the control unit to make the detection of the elementary particle more reliable.

According to one embodiment, the analog circuit comprises an analog chip configured to perform an analog reading of the electrical signal.

According to one embodiment, the analog circuit is configured to measure the time taken for electrons to cross the conductive grids.

According to one embodiment, the analog circuit uses a technology based on waveform detection, such as the system used by the circuit called SAMPIC as described in the document Delagnes et al. “The SAMPIC Waveform and Time to Digital Converter”, 2014 IEEE Nuclear Science Symposium and Medical Imaging Conference (2014 NSS/MIC).

According to one embodiment, the control unit is configured to:
calculate, for each crossing time, a corrected crossing instant by subtracting from each of the first crossing time, second crossing time, and third crossing time, a propagation time of the electrical signal between the conversion place and the location where the electrical signal corresponding to said crossing time is measured,
calculate a conversion instant corresponding to a time when the conversion of the elementary particle has taken place, said conversion instant being calculated from each corrected crossing instant, and from the position of the conversion dynode along the detection direction.

In this way, the temporal resolution of the detection is improved by a correction of the measured times.

According to one embodiment, the elementary particle detector comprises a reading plate disposed at the reading end of the detection direction, said reading plate comprising:
an outer face arranged so as to be struck by the electron avalanche; and
electrodes disposed next to each other on a face parallel to or coincident with the outer face.

Thus, it is possible to improve the spatial resolution and consequently the temporal resolution of measurement.

According to one embodiment, the reading plate comprises, in order, approaching its outer face:
a dielectric layer having a front face facing the outer face;
conductive strips forming the electrodes of the reading plate, these conductive strips extending mainly parallel to the front face in at least two different directions, each conductive strip being electrically connected to at least one first electrical charge sensor, these conductive strips being formed by:
   conductive tiles of micrometric or submicrometric dimensions, all identical to each other and all located at the same distance from the outer face, these conductive tiles being distributed on the front face of the dielectric layer and being mechanically separated from each other by a dielectric material, and
   electrical connections, located under the dielectric layer, which electrically connect in series conductive tiles so as to form said conductive strips, these electrical connections being arranged so that each conductive tile belongs to a single conductive strip and each side of a tile is adjacent to the side of another tile belonging to another conductive strip.

The arrangements described above make it possible to form a reading plate allowing spatial detection of the arrival of the improved electronic avalanche.

According to one embodiment, the elementary particle detector comprises an amplifier configured to amplify and/or rectify the electrical signal produced by the electrons generated during the conversion. According to one embodiment, the amplifier is included in the signal sensor such that it is also configured to allow the amplitude of the electrical signal to be measured. Thus, the amplifier then allows the dynode at which the conversion has taken place to be deduced.

For example, the amplifier is a logarithmic amplifier. The electrical signal produced by the electrons produced during the conversion in a dynode is then amplified significantly (for example by a factor of 1000) at each passage through the dynodes downstream of the dynode at which the conversion has taken place. The amplifier makes it possible to determine, as a function of the measured amplitude, at which dynode the conversion takes place.

According to one embodiment, the elementary particle detector comprises a voltage-applying device configured to place each conductive grid along the detection direction at a unique predetermined electrical potential. In this manner, it is possible to stagger the conductive grids at a unique predetermined potential.

The aim of the invention can also be achieved by implementing a method for detecting an elementary particle by an elementary particle detector as described above, the detection method comprising:
a step of providing said elementary particle detector;
a measuring step in which the at least one signal sensor measures an electrical signal produced by the accelerated electrons as they cross the conductive grids;
a determining step in which a conversion dynode corresponding to the dynode at which the conversion of the elementary particle has taken place is determined from the measured electrical signal.

The detection method may further have one or several of the following characteristics, taken alone or in combination.

According to one embodiment, the measuring step comprises measuring a first electrical signal, a second electrical signal, a third electrical signal, a first crossing time, a second crossing time, and a third crossing time; the detection method further comprising a locating step, in which the conversion place is determined by a lateralization method, as a function of the first, second, and third crossing times, and as a function of the position where the first, second, and third electrical signals are measured.

According to one embodiment, the detection method further comprises a calculating step in which, for each crossing time, a corrected crossing instant is calculated by subtracting from each of the first, second, and third crossing times, a propagation time of the electrical signal between the conversion place and the location where the electrical signal corresponding to said crossing time is measured, the calculating step then comprising calculating a conversion instant calculated from each corrected crossing instant, and from the position of the conversion dynode along the detection direction.

According to one embodiment, at least one step of the detection method can be implemented by a computer program product comprising code instructions recorded in a memory of the control unit, said code instructions being arranged to implement the detection method when the program is executed by a processor, said step being chosen from the determining step, the locating step, and the calculating step.

### BRIEF DESCRIPTION OF THE DRAWINGS

Other aspects, aims, advantages and characteristics of the invention will appear better on reading the following detailed description of preferred embodiments thereof, given by way of non-limiting example, and made with reference to the appended drawings in which:

FIG. 1 is a schematic side view of an elementary particle detector according to a first embodiment of the invention.

FIG. 2 is a schematic sectional view of an elementary particle detector according to a second embodiment of the invention.

FIG. 3 is a schematic side view of an elementary particle detector according to a third embodiment of the invention.

FIG. 4 is a schematic side view of an elementary particle detector according to a fourth embodiment of the invention.

FIG. 5 is a schematic perspective view of an elementary particle detector according to a fifth embodiment of the invention.

### DETAILED DESCRIPTION

In the figures and in the remainder of the description, the same references represent identical or similar elements. In addition, the different elements are not represented to scale so as to favor the clarity of the figures. Furthermore, the different embodiments and variants are not mutually exclusive and can be combined with each other.

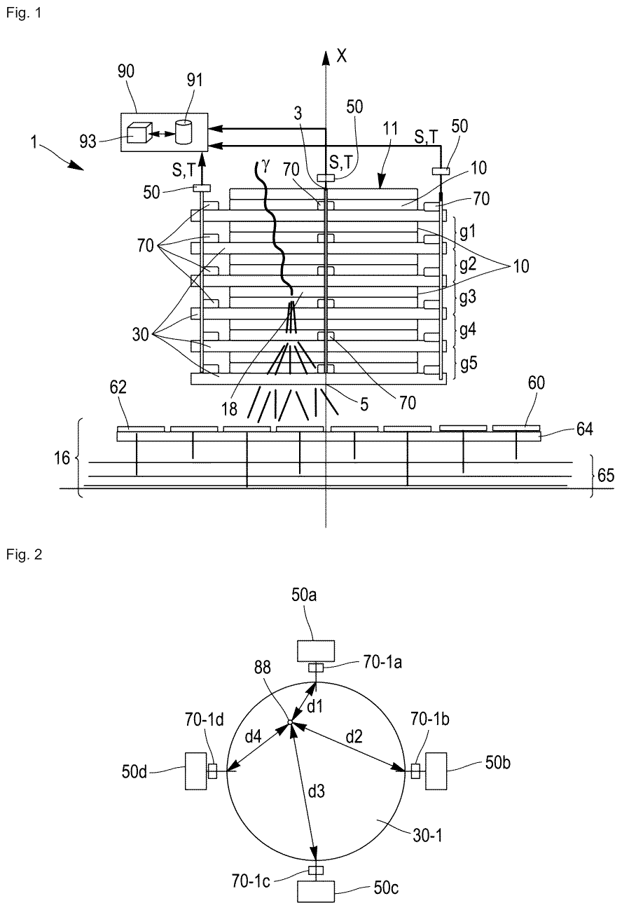

As illustrated in FIGS. 1 to 5, the invention relates to an elementary particle detector 1 configured to detect at least one elementary particle. For example, the elementary particle detector 1 may be configured to detect a time of flight of the elementary particle, for example for Positron Emission Tomography PET applications. More specifically, the elementary particle detector 1 according to the invention is particularly suitable for detecting gamma photons denoted “γ”.

The elementary particle detector 1 firstly comprises dynodes 10 stacked along a detection direction denoted “X” between a receiving end 3 and a reading end 5. In general, the dynodes 10 are microchannel plates 13 known by the acronym MCP. The dynode 10 is thus crossed, from one end to the other, by several million channels 13 often called “microchannels 13”. Consequently, the elementary particle detector 1 is one of the detectors known by the term “microchannel plate detector”. The general architecture and the operating principle of such detectors are known. For example, the reader can refer to patent FR3091953A1. Thus, hereinafter, only the elements necessary to understand the invention are described in detail.

In the remainder of the text, FIGS. 1, 3, and 4 are side views of the elementary particle detector 1, and are directed relative to the detection direction X, which in this case corresponds to a vertical direction pointing upwards. However, such an orientation is not limiting, and the detection direction X can be oriented in any direction. To simplify the understanding of the embodiments of the invention described in the figures, terms such as “next”, “previous”, “up”, “down”, “above” and “below”are defined relative to the detection direction X.

As can be seen in FIG. 1, each dynode 10 may comprise a receiving surface 11 at which the elementary particle is received. Each dynode 10 is capable of converting an elementary particle entering the dynode 10 into an electron avalanche. In particular, FIG. 1 shows a stack of six dynodes 10 each comprising a receiving surface 11 directed upwards, that is to say facing the receiving end 3. As indicated previously, the dynodes 10 comprise a plurality of channels 13 which comprise an emissive material capable, in response to an impact of said elementary particle, of generating, on average, more than one electron. The reader may refer to paragraphs [26] to [28] and to FIG. 2 of document FR3091953A1 which presents a mode of implementing these channels 13. In order to achieve amplification of the electron avalanche along the detection direction X, it is generally provided that each dynode 10 is arranged relative to the dynode 10 preceding it along the detection direction X so that the electrons coming from one of the channels 13 of the preceding dynode 10 are distributed across several channels 13 of this dynode 10. Thus, it is possible to increase the number of electrons in the electron avalanche, to amplify the signal to be detected. The reliability of the measurement is then improved. Advantageously, it may be provided that the dynodes 10 have a thickness, counted along the detection direction X, which is equal, to within 10%, to 500 μm. Dynodes 10 of 500 μm thickness are readily available commercially. Dynodes (or MCPs) of a thickness of a few millimeters may also be used.

The elementary particle detector 1 further comprises conductive grids 30, wherein each conductive grid 30 is either interposed between two adjacent dynodes 10 or disposed at the reading end 5 and/or at the receiving end 3. Each conductive grid 30 is capable of being crossed by electrons, so as not to stop the propagation of the electronic avalanche. Each conductive grid 30 is defined by a unique electrical potential to allow the application of a potential difference g1, g2, g3, g4, g5 with at least one other conductive grid 30 along the detection direction X. The term “unique electrical potential” means that the electrical potential of each conductive grid 30 is distinct from the electrical potentials of all the other conductive grids 30. In general, the elementary particle detector 1 comprises a voltage-applying device configured to place each conductive grid 30 along the detection direction X at its predetermined unique electrical potential. Generally, the unique electrical potentials defining the conductive grids 30 are negative. Thus the unique electrical potential defining the first dynode 10 disposed closest to the receiving end 3 is lower in algebraic value than that of the second dynode 10 which succeeds it along the detection direction X going towards the reading end 5, and so on. The potential difference g1, g2, 93, g4, g5 is likely to accelerate electrons between the two conductive grids 30. Generally, during the conversion of the elementary particle, the electrical signal generated by the electrons resulting from the conversion is contained in a given dynamic range, and specific to the considered imaging method. It is therefore advantageous to provide that the potential difference g1, g2, g3, g4, g5 is such that the gains of each of the detection stages are strictly greater than the dynamic range associated with each stage, and in particular at least 10 times greater than said dynamic range.

According to a non-limiting variant, the elementary particle detector 1 comprises an amplifier configured to amplify and/or rectify the electrical signal produced by the electrons generated during the conversion. As will be described later, the amplifier and the electronic chain associated with it can also be configured to measure the amplitude of an electrical signal S, for example a total electrical signal S. In general, the electrical signal S is a total electrical signal S, so reference will be made to a total electrical signal S in the remainder of the description. However, according to certain variants, the electrical signal S is not total, so a person skilled in the art can adapt the description by replacing the terms total electrical signal S with electrical signal S. Thus, the amplifier then makes it possible to deduce the dynode 10 at which the conversion has taken place. According to a non-limiting embodiment, the amplifier is a logarithmic amplifier. In this way, the electrical signal produced by the electrons generated during the conversion in a dynode 10 is amplified significantly (for example by a factor of 1000) at each passage through the dynodes 10 downstream of the dynode 10 at which the conversion has taken place. The amplifier makes it possible to determine, as a function of the measured amplitude, at which dynode 10 the conversion takes place.

According to a variant not represented, each dynode 10 comprises an emergence surface, opposite the receiving surface 11, at which the channels 13 of the dynode 10 open. This emergence surface of the dynodes 10 can be metallized, so that each emergence surface forms a conductive grid 30. In other words, each conductive grid 30 is included in a dynode 10 at the emergence surface. The arrangements described above make it possible in particular to form a transparent grid. The same is true for the receiving surface.

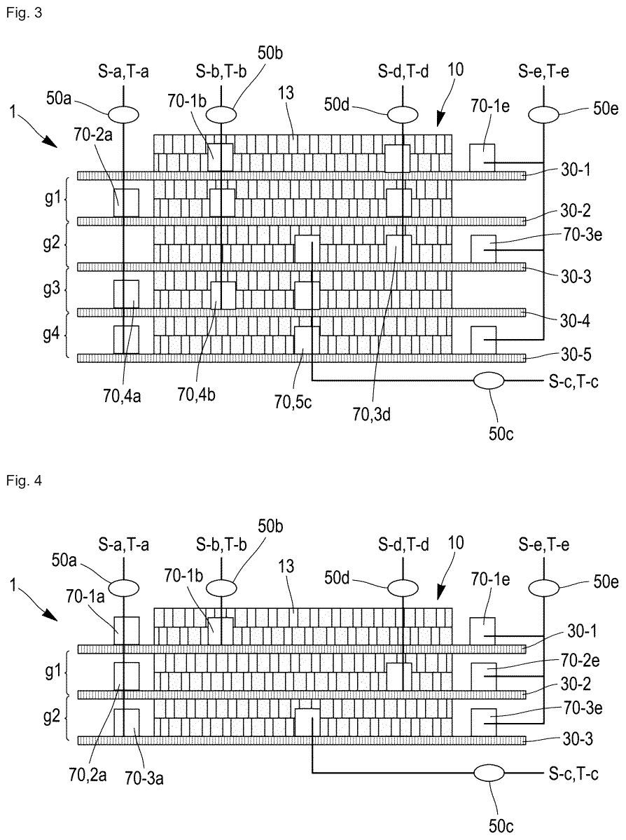

The elementary particle detector 1 then comprises at least one signal sensor 50 capable of measuring a total electrical signal S produced by the accelerated electrons as they cross the conductive grids 30. FIG. 1 illustrates a first embodiment in which the elementary particle detector 1 comprises three signal sensors 50. FIG. 2 illustrates a second embodiment in which the elementary particle detector 1 comprises four signal sensors 50a, 50b, 50c, 50d. Finally, FIG. 3 and FIG. 4 illustrate third and fourth embodiments in which the elementary particle detector 1 comprises five signal sensors 50a, 50b, 50c, 50d, and 50e which are respectively capable of measuring five total electrical signals S-a, S-b, S-c, S-d, and S-e. It is therefore well understood that the number of signal sensors 50 is not limiting, and that it can be adapted according to the precision of the desired measurement. However, the more the number of signal sensors 50 increases, the more the total manufacturing cost of the elementary particle detector 1 increases. Advantageously, the total electrical signal S measured by the signal sensors 50 depends on the potential differences g1, g2, 93, g4, g5 applied between the conductive grids 30.

According to a non-limiting variant, the at least one signal sensor 50 comprises an analog circuit configured to measure a total electrical amplitude of the total electrical signal S; and a time converter configured to measure a crossing time T of the electrons through the conductive grids 30. It is also possible for the signal sensor to be able to measure both an electrical amplitude and a crossing time T. Thus, the signal sensor 50 makes it possible to measure both the amplitude of a total electrical signal S, but also a crossing time T of the electrons. For example, the analog circuit comprises an analog chip configured to perform an analog reading of the total electrical signal S, and can be configured to measure the crossing time T of the electrons through the conductive grids 30. The analog circuit can use a technology based on waveform detection, such as for example the system used by the circuit called SAMPIC. The parameters detected by the signal sensor 50 are then used by the control unit 90 which will be described later, in order to make the detection of the elementary particle more reliable.

The elementary particle detector 1 may also comprise capacitive decoupling elements 70, wherein each capacitive decoupling element 70 is electrically connected to one of the conductive grids 30, and configured to provide an electrical isolation between the conductive grid 30 to which it is connected and the at least one signal sensor 50. Generally, the capacitive decoupling elements are configured to make it possible to withstand a potential difference of a few thousand, or even tens of thousands of volts.

The elementary particle detector 1 further comprises a control unit 90 configured to determine, from the total electrical signal S measured by the signal sensor 50, a conversion dynode 18 corresponding to the dynode 10 at which the conversion of the elementary particle has taken place. Indeed, each signal sensor 50 is designed to measure the characteristic electrical signal that appears when the conductive grid 30 to which it is connected is crossed by an electron avalanche. More precisely, when an electron avalanche crosses said conductive grid 30, this causes, by electromagnetic induction, the appearance of a charge peak in the conductive grid 30. This charge peak is amplified by the potential difference g1, g2, g3, 94, g5 defined between the conductive grids.

In general, the control unit comprises a processor 91 configured to execute a computer program comprising code instructions recorded in a memory 93 of the control unit 90. These code instructions are arranged to implement a detection method which will be described later. In the particular case of the conversion of the gamma photons γ, the conversion dynode 18 corresponds to the dynode 10 at which a gamma photon γ is converted. To determine the conversion dynode 18, the control unit 90 analyzes the measured total electrical signal S. Given that the electrical potentials of the conductive grids 30 are increasing along the detection direction X, the electrical gain of the total electrical signal S is therefore amplified correspondingly. Thus, knowing the unique electrical potentials of each conductive grid 30, it is possible to determine the dynode 10 at which the conversion of the elementary particle has taken place by using the amplitude of the signal. It is therefore well understood that it is the knowledge of the unique electrical potentials of the conductive grids 30 which makes it possible to determine the dynode 10 at which the conversion of the elementary particle has taken place. Indeed, taking into account the values of the chosen potential differences g1, g2, g3, g4, g5, it will be the largest gain value which will be predominant.

For example, in the case where all the potential differences g1, g2, g3, g4, g5 are identical, the conversion dynode 18 will be determined by the power of the obtained signal. In the case where the potential differences g1, g2, g3, g4, g5 increase in the detection direction X (i.e. gₙ>g_ₙ₋₁, where n is the number of the dynode 10 located at the nth position along the detection direction X), it is the power of the last potential difference that will predominate. According to one embodiment gₙ=xⁿ, where x is comprised between 10 and 100, and where n is the number of the dynode 10 located at the nth position along the detection direction X. Depending on the implemented embodiment, the elementary particle detector 1 can also make it possible to determine a conversion place 88 corresponding to a position on the conductive grid 30 located below the conversion dynode 18, and/or a conversion instant corresponding to a time when the conversion of the elementary particle has taken place. Such a determination of parameters is described below with reference to the embodiments presented in FIGS. 2 and 3.

FIG. 2 is a sectional view of an elementary particle detector 1 along a plane perpendicular to the detection direction X, at one of the conductive grids 30, and in particular at a first conductive grid 30-1. This figure illustrates in particular that the at least one signal sensor 50 comprises a first signal sensor 50a, a second signal sensor 50b, a third signal sensor 50c, and a fourth signal sensor 50d spaced apart from each other. The first signal sensor 50a is configured to measure a first total electrical signal S-a and a first crossing time T-a, the second signal sensor 50b is configured to measure a second total electrical signal S-b and a second crossing time T-b, the third signal sensor 50c is configured to measure a third total electrical signal S-c and a third crossing time T-c, and the fourth signal sensor 50d is configured to measure a fourth total electrical signal S-d and a fourth crossing time T-d. Each of the first, second, third, and fourth crossing times T-a, T-b, T-c, T-d corresponds to the instant when the corresponding total electrical signal S-a, S-b, S-c, S-d was detected by the corresponding signal sensor 50a, 50b, 50c, 50d.

The capacitive decoupling elements 70 comprise, for each conductive grid 30, and in particular for the first conductive grid 30-1, a first capacitive decoupling element 70-1a, a second capacitive decoupling element 70-1b, a third capacitive decoupling element 70-1c, and a fourth capacitive decoupling element 70-1d spaced apart from each other. These capacitive decoupling elements 70-1a, 70-1b, 70-1c, 70-1d are configured to provide an electrical isolation between the conductive grid 30-1 and the first, second, third and fourth signal sensors 50a, 50b, 50c, 50d respectively. Thus, it is possible to collect and measure the total electrical signal S along four separate measuring lines, said measuring lines being electrically isolated with respect to each conductive grid 30. In this way, it is possible to electrically isolate each measuring line from the electrical voltages applied to the conductive grids 30 while measuring a total electrical signal S.

Thanks to these arrangements, the control unit 90 can determine a conversion place 88 corresponding to the position where the conductive grid 30 disposed downstream of the conversion dynode 18 along the detection direction X is crossed by the electron avalanche. The conversion place 88 can for example be determined by a lateralization or triangulation method, as a function of the first crossing time T-a, the second crossing time T-b, the third crossing time T-c, and the fourth crossing time T-d; and as a function of the position where the first total electrical signal S-a, the second total electrical signal S-b, the third total electrical signal S-c, and the fourth total electrical signal S-d are measured. According to a first triangulation method, it is possible to determine the conversion place 88, by using the fact that there are several signal sensors 50a, 50b, 50c, 50d connected to the same conductive grid 30-1, and whose position around the conductive grid 30-1 is known. The propagation times of the total electrical signal S generated by the electron avalanche which crosses the conductive grid 30-1, to each of the signal sensors 50a to 50d are then not identical because the distances d1, d2, d3, and d4 to be covered are not the same. It is this difference between the propagation times which is exploited to determine the conversion place 88, by lateralization or triangulation. Then, the position of the conversion place 88 is established by combining the position of the signal sensors 50a, 50b, 50c, 50d around the grid 30-1.

Furthermore, the control unit 90 may be configured to calculate, for each crossing time T, a corrected crossing instant by subtracting from each of the first crossing time T-a, the second crossing time T-b, the third crossing time T-c, and the fourth crossing time T-d, a propagation time of the total electrical signal between the conversion place 88 and the location where the total electrical signal S corresponding to said crossing time T is measured, and to calculate a conversion instant corresponding to a time when the conversion of the elementary particle has taken place, said conversion instant being calculated from each corrected crossing time, the position of the conversion dynode 18 along the detection direction X, and possibly the position of the conversion place 88. In this way, the temporal resolution of the detection is improved by a correction of the measured times.

The arrangements described above make it possible to propose a particle detector configured to determine both the dynode 10 at which the conversion of the elementary particle has taken place, but also the conversion place 88 on the following conductive grid 30 corresponding approximately to the position where the conversion has taken place. The spatial and temporal resolution of the detection is thus improved. It is well understood that the conversion place 88 corresponds to a position on the conductive grid 30 located below the conversion dynode 18, the exact position of the conversion being located in the volume of the conversion dynode 18 near the conversion place 88.

The embodiment represented in FIG. 3 has a substantially identical mode of operation to that represented in FIG. 2, the principles developed for the embodiment of FIG. 2 can therefore be transposed to the embodiment of FIG. 3. In FIG. 3, the elementary particle detector 1 comprises five dynodes 10 and five conductive grids 30-1, 30-2, 30-3, 30-4, 30-5. The control unit 90 (not represented) receives total electrical signals S-a, S-b, S-c, S-d, S-e from five signal sensors 50a, 50b, 50c, 50d, 50e. However, these five signal sensors 50a, 50b, 50c, 50d, 50e are not all capable of measuring the total electrical signals S-a, S-b, S-c, S-d, S-e (and possibly the crossing times T-a to T-e) at all the conductive grids 30-1, 30-2, 30-3, 30-4, 30-5. Indeed, taking the example of the first signal sensor 50a, the latter is capable of measuring a first total electrical signal S-a, and a first crossing time T-a only at the conductive grids 30-2, 30-4, and 30-5. The five signal sensors 50a, 50b, 50c, 50d, 50e are electrically isolated from the five conductive grids 30-1, 30-2, 30-3, 30-4, 30-5 through the capacitive decoupling elements numbered by the formula 70-yz, where y corresponds to the number of the conductive grid 30-y for 30-1, 30-2, 30-3, 30-4, and 30-5; and where z corresponds to the signal sensor 50z for 50a, 50b, 50c, 50d, 50e. For example, the capacitive decoupling element 70-4a makes it possible to electrically isolate the conductive grid 30-4 and the signal sensor 50a.

Thanks to such an architecture, by receiving the total electrical signals S-a, S-b, S-c, S-d, S-e from the five signal sensors 50a, 50b, 50c, 50d, 50e, the control unit 90 can more easily determine at which dynode 10 the conversion has taken place. Typically, if the conversion has taken place at the fourth dynode 10 from the top, the fourth signal sensor 50d will not pick up an electrical signal. Such an architecture makes it possible to provide a redundant means for determining the position of the conversion dynode 18.

According to another embodiment represented in FIG. 4 which also has a mode of operation substantially identical to that of FIGS. 2 and 3, the elementary particle detector 1 comprises three dynodes 10 and three conductive grids 30-1, 30-2, 30-3. The control unit 90 (not represented) receives electrical signals S-a, S-b, S-c, S-d, S-e, S-f (and possibly the crossing times T-a to T-f) from six signal sensors 50a, 50b, 50c, 50d, 50e, 50f. To simplify the reading of FIG. 4, and taking into account the fact that FIG. 4 is a sectional view, the signal sensor 50f configured to detect the total electrical signal S-f and the crossing time T-f has not been represented. However, among these six signal sensors 50a, 50b, 50c, 50d, 50e, and 50f, only the sensors 50a, 50e, and 50f are capable of measuring the total electrical signals S-a, S-e, and S-f at all of the conductive grids 30-1, 30-2, 30-3, 30-4, 30-5. The other signal sensors 50b, 50c, and 50d are configured to measure the electrical signals S-b, S-c, and S-d measured at each of the conductive grids 30-1, 30-2, and 30-3, respectively. Furthermore, and as detailed above, the six signal sensors 50a, 50b, 50c, 50d, 50e, and 50f are electrically isolated from the five conductive grids 30-1, 30-2, 30-3, 30-4, 30-5 through the capacitive decoupling elements numbered by the formula 70-yz, where y corresponds to the number of the conductive grid 30-y for 30-1, 30-2, 30-3, 30-4, and 30-5; and where z corresponds to the signal sensor 50z for 50a, 50b, 50c, 50d, 50e, and 50f.

Thanks to such an architecture, by receiving the electrical signals S-b, S-c, and S-d, from the three signal sensors 50b, 50c, and 50d, the control unit 90 can determine the dynode 10 where the conversion has taken place. The electrical signals S-a, S-e, and S-f make it possible to confirm the conversion dynode 18 and determine by lateralization the coordinates of the conversion in the plane parallel to the conductive grids 30.

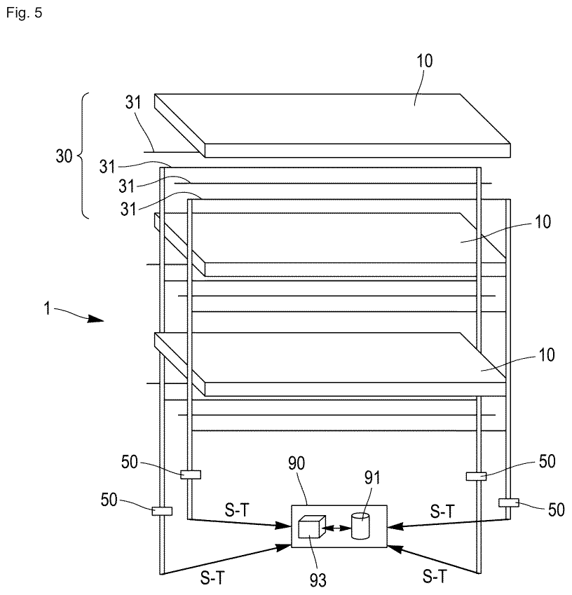

The embodiment represented in FIG. 5 presents an alternative variant for detecting the total electrical signals S at the conductive grids 30. This embodiment is not limiting and can be fully adapted to the previous embodiments as a replacement or in addition to the transparent conductive grids 30. According to this embodiment, the conductive grid 30 comprises a plurality of delay lines 31 which are separated from each dynode 10. Thus, it is not necessary to provide capacitive decoupling elements 70, since the delay lines 31 are already electrically isolated from the dynodes 10. These delay lines 31 are chosen to be sufficiently thin to allow the formation of a conductive grid 30 which is sufficiently transparent to the passage of the electrons. Each delay line 31 is connected, at each of its ends, to a signal sensor 50. Furthermore, each delay line 31 can be electrically connected to a delay line 31 belonging to the next conductive grid 30 along the detection direction X. In this way, is possible to measure total electrical signals S at the end of each delay line 31. As illustrated in FIG. 5, the delay lines 31 disposed at the second and fourth positions of each conductive grid 30 are electrically connected at their respective ends, so as to measure four total electrical signals S. To simplify the reading of FIG. 5, the other electrical connections between the delay lines 31 have not been represented, but are also used in this embodiment. By comparing the total electrical signals S measured at both ends of each delay line 31, it is possible to determine the conversion place.

Finally, and as illustrated in FIG. 1, the elementary particle detector 1 may comprise a reading plate 16 disposed at the reading end 5 of the detection direction X. The reading plate 16 comprises an outer face 60 arranged so as to be struck by the electron avalanche, and electrodes 62 disposed next to each other in a face parallel to or merged with the outer face 60. For example, the reading plate 16 comprises, in order, approaching its outer face 60:
a dielectric layer 64 having a front face facing the outer face 60;
conductive strips forming the electrodes 62 of the reading plate 16, these conductive strips extending mainly parallel to the front face in at least two different directions, each conductive strip being electrically connected to at least one first electrical charge sensor, these conductive strips being formed by:
   conductive tiles, of micrometric or submicrometric dimensions, all identical to each other and all located at the same distance from the outer face 60, these conductive tiles being distributed on the front face of the dielectric layer 64 and being mechanically separated from each other by a dielectric material, and
   electrical connections 65, located under the dielectric layer 64, which electrically connect in series conductive tiles so as to form said conductive strips, these electrical connections 65 being arranged so that each conductive tile belongs to a single conductive strip and each side of a tile is adjacent to the side of another tile belonging to another conductive strip.

The arrangements described above make it possible to form a reading plate 16 allowing improved spatial detection of the arrival of the electronic avalanche. It will in fact make it possible to better measure the coordinates of the conversion point in a plane parallel to the receiving surface. This determination will thus allow a better temporal measurement of the arrival of the elementary particle because it makes it possible to better subtract the propagation time of the electrical signal S between the conversion point and the signal sensors 50, knowing the propagation speed of the signal on the conductive grids 30 or the delay lines 31.

The reader may refer to documents FR3062926A1 and FR3091953A1 which disclose reading grids 16 which can be simply adapted to the elementary particle detector 1 according to the invention.

All of the elements described above make it possible to propose a low-cost elementary particle detector 1, with improved conversion efficiency, while keeping good time resolution. Indeed, the absence of fast-response crystals for converting elementary particles makes it possible to reduce the manufacturing cost of the elementary particle detector 1. In addition, the application of unique electrical potentials between the conductive grids 30 makes it possible to have gain jumps after each dynode 10 starting from the conversion dynode 18 and thus to use the amplitude of the signal to effectively determine at which dynode 10 the conversion of the elementary particle has taken place, this determination being carried out with reduced detection electronics.

The invention can also be implemented by a detection method for detecting an elementary particle by an elementary particle detector 1 as described above. The detection method therefore comprises a step of providing said elementary particle detector 1, and a measuring step in which the at least one signal sensor 50 measures a total electrical signal S produced by the accelerated electrons when they cross the conductive grids 30. In the case where the elementary particle detector 1 comprises several signal sensors 50a, 50b, 50c, the measuring step can then comprise measuring a first total electrical signal S-a, a second total electrical signal S-b, a third total electrical signal S-c, a first crossing time T-a, a second crossing time T-b, and a third crossing time T-c. The detection method can then comprise a locating step, in which the conversion place 88 is determined by a lateralization method, as a function of the first, second, and third crossing times T-a, T-b, T-c, and as a function of the position where the first, second, and third total electrical signals S-a, S-b, S-c are measured.

The detection method also comprises a determining step in which a conversion dynode 18 corresponding to the dynode 10 at which the conversion of the elementary particle has taken place is determined from the measured total electrical signal S.

Finally, the detection method may further comprise a calculating step in which, for each crossing time T, a corrected crossing instant is calculated by subtracting from each of the first, second, and third crossing times T-a, T-b, T-c, a propagation time of the total electrical signal between the conversion place 88 and the location where the total electrical signal S corresponding to said crossing time T is measured, the calculating step then comprising calculating a conversion instant calculated from each corrected crossing instant, and from the position of the conversion dynode 18 along the detection direction X.

According to one embodiment, at least one step of the detection method can be implemented by a computer program product comprising code instructions recorded in the memory 93 of the control unit 90, said code instructions being arranged to implement the detection method when the program is executed by the processor 91, said step being chosen from the determining step, the locating step, and the calculating step.

The invention finds various applications such as particle and high energy physics, in particular for calorimeters, but also in the field of medical imaging for PET-Scans, in particular for the purposes of aiding in the diagnosis and detection of cancers or analysis of the effectiveness of cancer treatments. The invention can also be used in the fields of microscopy and mass spectrometry.

1. An elementary particle detector configured to detect at least one elementary particle, the elementary particle detector comprising:
dynodes stacked along a detection direction between a receiving end and a reading end, wherein each dynode is capable of converting an elementary particle entering the dynode into an electron avalanche, the dynode comprising a plurality of channels which comprise an emissive material capable, in response to an impact of the elementary particle, of generating, on average, more than one electron;
conductive grids where each conductive grid is either interposed between two adjacent dynodes or disposed at the reading end and/or at the receiving end, each conductive grid being capable of being crossed by electrons, and being defined by a unique electrical potential to allow the application of a potential difference with at least one other conductive grid along the detection direction, the potential difference being likely to accelerate electrons between the two conductive grids, each unique electrical potential being chosen so that the unique electrical potential of the conductive grid is strictly lower than the unique electrical potential applied to the conductive grid which succeeds it along the detection direction;
at least one signal sensor capable of measuring an electrical signal produced by the accelerated electrons when they cross the conductive grids, the electrical signal depending on the potential differences applied between the conductive grids;
a control unit configured to determine, from the electrical signal measured by the signal sensor, a conversion dynode corresponding to the dynode at which the conversion of the elementary particle has taken place.

2. The elementary particle detector according to claim 1, wherein each dynode comprises a receiving surface at which the electrons or the elementary particle are received, and an emergence surface opposite the receiving surface, the emergence surface forming a conductive grid.

3. The elementary particle detector according to claim 1, wherein each dynode is arranged relative to the dynode preceding it along the detection direction so that the electrons which come from one of the channels of the preceding dynode are distributed in several channels of this dynode, so as to amplify the electron avalanche.

4. The elementary particle detector according to claim 1, comprising capacitive decoupling elements, wherein each capacitive decoupling element is electrically connected to one of the conductive grids, and configured to provide an electrical isolation between the conductive grid to which it is connected and the at least one signal sensor.

5. The elementary particle detector according to claim 4, wherein the at least one signal sensor comprises a first signal sensor, a second signal sensor and a third signal sensor spaced apart from each other, and wherein the capacitive decoupling elements comprise, for each conductive grid, a first capacitive decoupling element, a second capacitive decoupling element, and a third capacitive decoupling element spaced apart from each other; the first capacitive decoupling element being configured to provide an electrical isolation between the conductive grid and the first signal sensor, the second capacitive decoupling element being configured to provide an electrical isolation between the conductive grid and the second signal sensor, and the third capacitive decoupling element being configured to provide an electrical isolation between the conductive grid and the third signal sensor.

6. The elementary particle detector according to claim 5, wherein:
the first signal sensor is configured to measure a first electrical signal and a first crossing time;
the second signal sensor is configured to measure a second electrical signal and a second crossing time;
the third signal sensor is configured to measure a third electrical signal and a third crossing time;
the control unit is then configured to determine a conversion place corresponding to the position where the conductive grid disposed downstream of the conversion dynode along the detection direction is crossed by the electron avalanche, the conversion place being determined by a lateralization method, as a function of the first crossing time, the second crossing time, and the third crossing time, and as a function of the position where the first electrical signal, the second electrical signal, and the third electrical signal are measured.

7. The elementary particle detector to claim 1, wherein the at least one signal sensor comprises:
an analog circuit configured to measure a total electrical amplitude of the electrical signal and
a time converter configured to measure a crossing time of the electrons through the conductive grids.

8. The elementary particle detector according to claim 6, wherein the control unit is configured to:
calculate, for each crossing time, a corrected crossing instant by subtracting from each of the first crossing times, the second crossing time, and the third crossing time, a propagation time of the total electrical signal between the conversion place and the location where the electrical signal corresponding to the crossing time is measured,
calculate a conversion instant corresponding to a time when the conversion of the elementary particle has taken place, the conversion instant being calculated from each corrected crossing instant, and from the position of the conversion dynode along the detection direction.

9. The elementary particle detector according to claim 1, comprising a reading plate disposed at the reading end of the detection direction, the said reading plate comprising:
an outer face arranged so as to be struck by the electron avalanche; and
electrodes disposed next to each other in a face parallel to or merged with the outer face.

10. The elementary particle detector according to claim 9, wherein the reading plate comprises, in order, approaching its outer face:
a dielectric layer having a front face facing the outer face;
conductive strips forming the electrodes of the reading plate, these conductive strips extending mainly parallel to the front face in at least two different directions, each conductive strip being electrically connected to at least one first electrical charge sensor, these conductive strips being formed by:
conductive tiles, of micrometric or submicrometric dimensions, all identical to each other and all located at the same distance from the outer face, these conductive tiles being distributed on the front face of the dielectric layer and being mechanically separated from each other by a dielectric material, and
electrical connections, located under the dielectric layer, which electrically connect in series conductive tiles so as to form the conductive strips, these electrical connections being arranged so that each conductive tile belongs to a single conductive strip and each side of a tile is adjacent to the side of another tile belonging to another conductive strip.

11. A method for detecting an elementary particle by an elementary particle detector according to claim 1, the detection method comprising:
a step of providing the elementary particle detector;
a measuring step in which the at least one signal sensor measures an electrical signal produced by the accelerated electrons as they cross the conductive grids;
a determining step in which a conversion dynode corresponding to the dynode at which the conversion of the elementary particle has taken place is determined from the measured electrical signal.

12. A method for detecting an elementary particle by an elementary particle detector according to claim 6, the detection method comprising:
a step of providing the elementary particle detector;
a measuring step in which the at least one signal sensor measures an electrical signal produced by the accelerated electrons as they cross the conductive grids;
a determining step in which a conversion dynode corresponding to the dynode at which the conversion of the elementary particle has taken place is determined from the measured electrical signal,
the measuring step then comprising measuring a first electrical signal, a second electrical signal, a third electrical signal, a first crossing time, a second crossing time, and a third crossing time; the detection method further comprising a locating step, in which the conversion place is determined by a lateralization method, as a function of the first, second, and third crossing times, and as a function of the position where the first, second, and third electrical signals are measured.

13. A method for detecting an elementary particle by an elementary particle detector according to claim 8, the detection method comprising:
a step of providing the elementary particle detector;
a measuring step in which the at least one signal sensor measures an electrical signal produced by the accelerated electrons as they cross the conductive grids;
a determining step in which a conversion dynode corresponding to the dynode at which the conversion of the elementary particle has taken place is determined from the measured electrical signal,
the measuring step then comprising measuring a first electrical signal, a second electrical signal, a third electrical signal, a first crossing time, a second crossing time, and a third crossing time; the detection method further comprising a locating step, in which the conversion place is determined by a lateralization method, as a function of the first, second, and third crossing times, and as a function of the position where the first, second, and third electrical signals are measured,
the detection method further comprising a calculating step in which for each crossing time, a corrected crossing instant is calculated by subtracting from each of the first, second, and third crossing times, a propagation time of the electrical signal between the conversion place and the location where the electrical signal corresponding to the crossing time is measured, the calculating step then comprising calculating a conversion instant calculated from each corrected crossing instant, and from the position of the conversion dynode along the detection direction.
